(19) United States
(12) Patent Application Publication
(10) Pub. No.: US 2019/0242527 A1
(43) Pub. Date: Aug. 8, 2019

(54) METHOD AND DEVICE FOR WITHDRAWING VAPOR AND MEASURING LIQUID LEVEL IN A CYLINDER CONTAINING LIQUEFIED GAS

(71) Applicant: David Milner, Long Valley, NJ (US)

(72) Inventor: David Milner, Long Valley, NJ (US)

(21) Appl. No.: 16/149,488

(22) Filed: Oct. 2, 2018

Related U.S. Application Data
(60) Provisional application No. 62/627,832, filed on Feb. 8, 2018.

(51) Int. Cl. F17C 13/02; G01F 23/26; G01F 23/24; G01F 23/296; F17C 13/04; F17C 1/14

(52) U.S. Cl. CPC F17C 13/02; G01F 23/263; G01F 23/24; G01F 23/296; F17C 2250/0417; F17C 1/14; F17C 2250/0491; F17C 2201/0119; F17C 2203/0643; F17C 13/04

(57) ABSTRACT

A cylinder for liquefied gas that includes a withdrawal tube that prevents liquid product from the cylinder from being inadvertently dispensed to the tool downstream. The cylinder also includes a level measuring means used to determine the remaining liquid level in the cylinder. A low power level display to indicate low levels of liquid in the cylinder using a minimum of power consumption may also be included.

### CROSS REFERENCE TO RELATED APPLICATIONS

This application claims priority from U.S. provisional patent application Ser. No. 62/627,832 filed on Feb. 8, 2018.

### BACKGROUND OF THE INVENTION

The present invention relates to a liquefied gas delivery vessel, e.g. a cylinder or canister (cylinder used throughout document)

Cylinders that contain liquefied gases at thermal equilibrium with the surroundings contain product in both liquid and gaseous phase. In some applications it is critical that liquid is not allowed to enter the outlet of the cylinder. This can be because of safety concerns, or because of equipment limitations, or because of downstream process limitations.

Cylinders that contain liquefied gases at thermal equilibrium with the surroundings experience the problem that the pressure in the vapor space remains constant as the liquid level falls until all the liquid has completely vaporized. At that point the pressure in the cylinder, which now contains only vapor, will begin to decrease. However, it is not possible to determine, or infer, how much material remains in the cylinder based on pressure or temperature readings. Therefore, the typical method used is to weigh the cylinder and its contents during use and then determine the remaining amount of material based on weight change from the start of the usage. This method requires cylinder manipulation to enable weighing and can be very difficult, particularly when cylinders are stored in a storage rack of a gas cabinet as there is no space to incorporate a weighing scale.

There is a need in the art for improvements in the vapor withdrawal mechanism to ensure that liquid phase product cannot be withdrawn from the cylinder—regardless of what has happened to the cylinder prior to it being connected to the delivery system.

There is a need in the art for improvements to determining the amount of liquid remaining in a liquefied gas cylinder.

### SUMMARY OF THE INVENTION

The invention includes a central withdrawal tube used to withdraw vapor from the cylinder. The withdrawal tube is placed to as to withdraw vapor from a central location within the cylinder. For purposes of the present invention, it is desirable that the withdrawal tube not have any bends in it because rotation and agitation of the cylinder during transportation and handling can trap liquid in the low point. For operation integrity, the cylinder is filled to a maximum of 40% of its volume. In this way, it is ensured that no matter how the cylinder is handled or installed in the tool no liquid can enter the withdrawal tube. To further ensure integrity of the delivery, the withdrawal tube is equipped with a sintered metal frit incorporated into the internal end of the withdrawal tube. Because the general process application for such cylinders use very low flow rates, any resistance to flow caused by the frit is negligible and not a factor. If the cylinder is moved, it should be left stationary for a short period of time, e.g. a minute or two, so that any splashing of liquid that does occur and might get past the sintered frit, is able to drain back out under gravity.

Depending on the type of level measuring selected, the cylinder may require installation in a specific orientation. In this instance, indexing devices are incorporated in the cylinder design so that it will lie horizontally in a gas cabinet in the correct orientation. An alternative withdrawal tube design is another embodiment of the present invention. This withdrawal tube design has a conical taper on the inside. Even if liquid does get past the frit on the end of the tube, when the cylinder is left for a minute at something close to horizontal (or any other angle where the withdrawal valve is above the withdrawal tube) the liquid can freely drain back into the cylinder by gravity. The liquid fill level should still be below the withdrawal point when the cylinder is horizontal. At low vapor withdrawal rates any droplets remaining at the lower edge of the tapered withdrawal tube will not be entrained in the vapor stream flowing above it as a result of the large surface area reducing the face velocity even lower than the tube velocity.

The liquid level measuring device is selected from the group consisting of an ultrasonic sensor, an acoustic sensor, a conductivity probe, a capacitance probe, and a continuity sensor.

A liquid is present in the hollow body and comprise up to 40% by volume of the hollow body.

The at least one valve assembly is a product withdrawal tube for withdrawing vapor from the hollow body.

A low liquid level display mounted on the circular top segment. This low liquid level display can be an indicator comprising a green light emitting diode light and a red light emitting diode light.

The low liquid level display may be mounted on an end of the liquid level measuring device not in the hollow body.

A sintered metal frit may be mounted on an end of the valve assembly in the hollow body.

A fill port may extend through the circular top segment into the hollow body of the liquid gas cylinder. However, this fill port may be located in other sections of the liquid gas cylinder based on cylinder design, usage, storage parameters, etc. The product withdrawal tube comprises a tube having substantially parallel walls. In an alternative embodiment, the product withdrawal tube comprises a tube having walls which are conically tapered so that the walls at a front end of the tube are closer than the walls at a back end of the tube.

The liquid gas cylinder may be transported in any position selected from the group consisting of horizontally, vertically and at an angle between horizontal and vertical or inverted.

The liquid gas cylinder may be mounted in a position selected from the group consisting of horizontally, vertically and at an angle between horizontal and vertical.

The level sensor as discussed above are situated in the hollow body to allow them to sense when the liquid volume is 10% by volume of the hollow body.

The liquid gas cylinder may have indexing feet mounted on the exterior surface of the hollow body.

The liquid gas cylinder is mounted on a tool for delivery of gas to the tool.

The user of the tool can be notified when approximately 10% by volume of liquid remains in the hollow body.

### BRIEF DESCRIPTION OF THE DRAWINGS

FIG. 1 is a schematic of a typical cylinder.

FIG. 2 is a schematic of a different vapor withdrawal tube configuration showing a tapered wall construction.

FIG. 3 is a top down view of a display assembly on a cylinder according to the invention.

For purposes of the description, where the same parts are used in different drawing figures, they will bear the same numbers.

### DETAILED DESCRIPTION OF THE INVENTION

The invention includes a central withdrawal tube used to withdraw vapor from the cylinder. The withdrawal tube is placed so as to withdraw vapor from a central location within the vessel or cylinder. For operational integrity, the cylinder is filled to a maximum of 40% of its volume. In this way, it is ensured that no matter how the vessel is handled or installed in the tool that no liquid can enter the withdrawal tube. To further ensure integrity of the delivery, the withdrawal tube is equipped with a sintered metal frit incorporated into the internal end of the withdrawal tube. Because the general process application for such cylinders use very low flow rates, any resistance to flow caused by the frit is negligible and not a factor. If the vessel is moved, it should be left stationary for a short period of time, e.g. a minute or two, so that any splashing of liquid that does occur and might get past the sintered frit, is able to drain back out under gravity.

An alternative withdrawal tube design embodiment is further proposed. This embodiment has a conical taper on the inside of the withdrawal tube. Even if liquid does get past the frit on the end, when the vessel is left for a short period of time at something close to horizontal (or any other angle where the withdrawal valve is above the withdrawal tube) the liquid can freely drain back into the vessel by gravity. The liquid fill level should still be below the withdrawal point when the vessel is horizontal. At low vapor withdrawal rates, any droplets remaining at the lower edge of the tapered withdrawal tube will not be entrained in the vapor stream flowing above it as a result of the large surface area reducing the face velocity to even lower than the tube velocity.

The liquid level sensing device must be able to work with the cylinder in any normal operating position, e.g. almost horizontal or almost vertical It is most important to know that there is still some liquid remaining, while the actual amount of remaining liquid is not an important factor. Therefore, the level measuring device can be approximate as long as it will continue to detect the presence of any liquid in any practical cylinder operating orientation. The level measuring methods can be adapted from commercially available technology, such as level measurement probes using the principles of capacitance, conductance, ultrasonic, acoustic or circuit continuity.

The low power level display is designed as a battery powered electronic device that operates in a mode so as to minimize power consumption. For example, wireless portable thermostats for the control of house heating and cooling or battery powered smoke detectors use technology wherein the device “wakes up” from a low power standby mode to take a sample, flash a green LED momentarily and go back into low power “sleep” mode again until the internal timer re-activates the device to take another reading.

It is preferred that a customer not need to make changes to a tool or operating system in order to adopt a new molecule and delivery system. Therefore, the invention provides a system that is self-sufficient, to the extent possible, between the time of filling the cylinder and delivery to the customer and the time it is returned for refilling.

As noted above, the vessel or cylinder is designed to have a central withdrawal point and is only filled to 40% full with product as shown in the description of the drawings to follow.

The sintered metal frit according to the invention is shown incorporated into the internal end of the withdrawal tube.

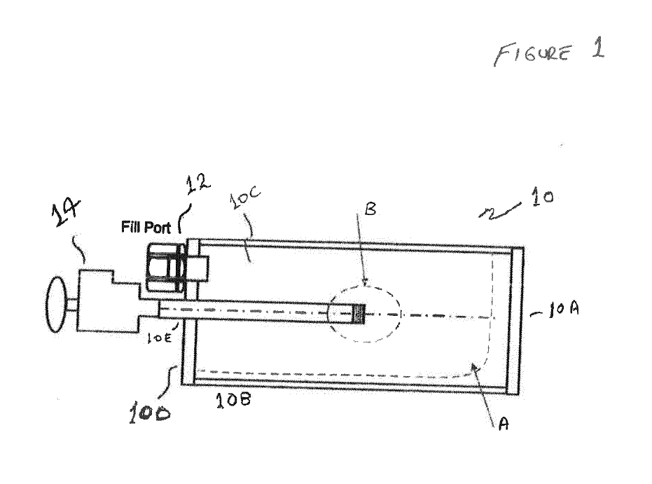

The cylinder 10 shown in FIG. 1 is a typical cylinder that can hold liquids. The cylinder 10 comprises a hollow body 10C whose length is a vertical wall 10B having interior and exterior surfaces connected to a circular bottom segment 10A and a circular top segment 10D wherein the circular top segment 10D has an opening 10E to allow the passage of at least one valve assembly 14. This at least one valve assembly 14 is a product withdrawal valve that extends into the center of the cylinder 10. A fill port 12 is also present allowing for the entry of liquids into the cylinder 10.

At the end of the product withdrawal valve 14 the line B marks the level at which the cylinder 10 is 40% full regardless of the physical orientation of the cylinder. The curved line labelled A is the point at which the cylinder 10 is 10% full regardless of its physical orientation.

With respect to liquid level measurement there are two aspects to the solution that need to be considered. The first aspect is the actual level sensing and second aspect is the electronics and display. The sensing does not need to be proportional level indication. Rather it is sufficient that the customer knows that there is either more or less than approximately 10% of the liquid remaining in the vessel. In order to maintain the system integrity, some flexibility in the orientation of the cylinder must be sacrificed. In particular, it is not possible to have an inverted cylinder nor can the cylinder be installed in all horizontal orientations. If the cylinder is installed incorrectly, the design would still prevent liquid from being withdrawn through the withdrawal tube. Therefore, a notice is provided on the cylinder indicating which direction should be facing ‘UP’. Further, the liquid will be indicated lower than it is in practice. This provides fail safe events that avoid problems being caused to process operations.

The liquid level measuring device can be of known technology, such as a conductivity probe, a capacitance probe, a capacitance probe to vessel, acoustic or ultrasonic sensor or circuit continuity to vessel. Each of these types of devices will work in any of the different vessel orientations described below.

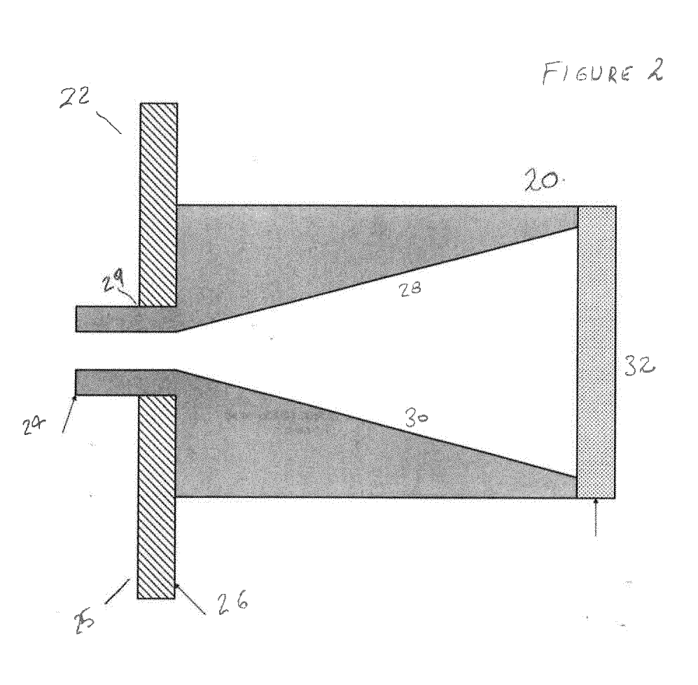

FIG. 2 is a cross sectional schematic of an outlet valve assembly 20. The vessel wall or head 22 has an outer surface 25 and an inner surface 26 where the outlet valve assembly abuts the inner surface 26. An opening 29 in the vessel wall or head 22 allows for passage of the outlet valve assembly 20 to pass through the vessel wall or head 22 for withdrawal of the contents of the vessel.

The outlet valve assembly 20 has an interior section which is marked by two interior walls 28 and 30. As shown in FIG. 2, the interior walls 28 and 30 are positioned at approximately the size of the opening 29 where the outlet valve assembly 20 abuts the vessel wall or head 22. As the interior walls 28 and 30 progress along the length of the outlet valve assembly 20 away from the opening 29, they diverge in distance from each other in a tapered manner such that at the end of the outlet valve assembly 20 opposite from the opening at the frit 32, the interior walls 28 and 30 are further apart than at the opening 29.

This tapering of the interior walls 28 and 30 will inhibit liquid from becoming trapped in the event that the vessel is situated in a not quite horizontal manner. The taper will facilitate the flow of trapped liquid back into the vessel.

The frit 32 is situated at the opposite end from the opening 29 of the outlet valve assembly 20. The frit 32 is designed to minimize liquid entry into the outlet valve assembly 20 during transportation and handling of the vessel.

The invention also relates to display of the level indicator. Many electronic gas customers may be resistant to smart devices being connected to the Internet or to a wireless telephone network and therefore may require a passive system that has no external connections.

The simplest level display would comprise dedicated electronics built into the top of the measuring probe assembly that provides an indication when the liquid level is less than a predetermined amount, e.g. less than approximately 10% of the vessel volume. The consumption rate of material in the vessel tends to be very slow, e.g. on the order of 3 to 6 months. This means that a level check event occurring once per day should be adequate. However, any other desirable interval can be chosen, based on battery life, frequency of account servicing and other factors.

The indicator may be a simple LED light system. For example, a green LED light may flash once every 30 seconds if the level is acceptable. When the low level is detected a red LED would flash every 30 seconds. Once the red light starts, the process would start an internal timer to gradually speed up the red LED flash frequency over a pre-determined period, such as over a week, the flash rate starting at once every 30 seconds and speeding up 5 seconds faster each day. This would be an effective way to notify the customer that the cylinder needs to be changed out.

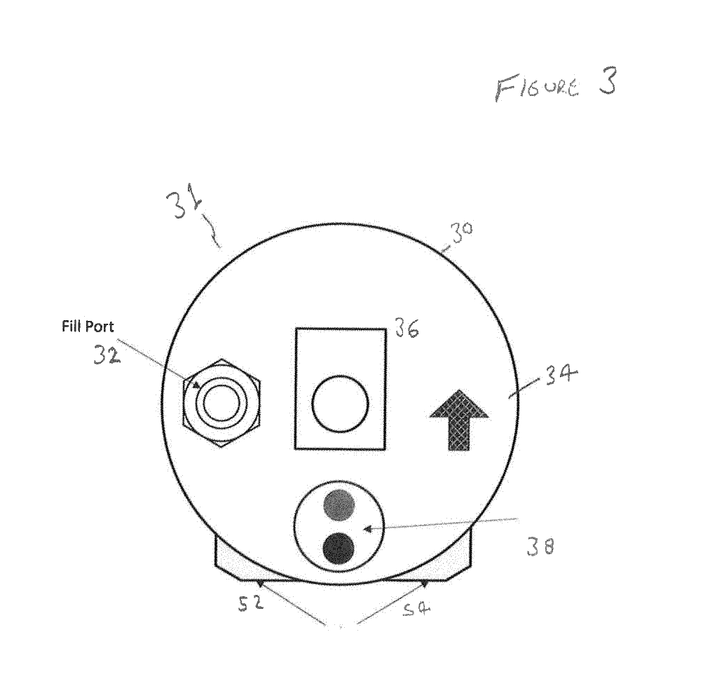

An indicator of this type is shown in FIG. 3. The indicator 38 may be built into the top of the capacitance or conductivity probe (not shown). The indicator 38 will appear on the circular top segment 30 of a cylinder 31 looking from the top of the cylinder 31 downwards. The fill port would be represented by 32 and the valve assembly by 36. An arrow 34 can be etched into the circular top segment 30 to indicate the upright position when the cylinder is laid horizontally. The indicator 38 could be two lights, red and green for example, where the top light is green and the bottom light is red. As noted above, these would alert the user of the cylinder as to the status of the level of liquid present in the cylinder.

Indexing feet 52 and 54, which allow for positioning, adjusting and leveling of the cylinder 31 are shown at the bottom of the cylinder 31.

Alternatively, an even lower power consumption approach is to have a button on the sensor that is physically operated to provide a read out only on demand—such as when an operator is making a daily inspection.

Another embodiment to is to hardwire the sensor to a data reader that can then be connected to the tool supervisory system as described in greater detail below.

If a customer accepts or welcomes Smart technology and active support of the cylinder with notification to change it out, then an electronic smart valve collar technology could be used. This represents a more sophisticated option and does involve information being transmitted from the customer facility to outside their area of control. This technology would also support proportional level control to be incorporated into the system, which would allow for tracking of customer use profiles and enable more proactive re-stocking and notification to the customer.

A commercially available liquid sensing probe with multiple level detection of WET or DRY could be used. Typically, these probes need to be connected by a multicore cable with quick disconnect capability to an external module that provides power and level readings from the onboard sensors. The level indications are discrete. However, if the level indicator is connected to the tool supervisory control and data acquisition (SCADA) system some simple mathematics based on average, historic consumption and run time could be applied to give a continuous estimated level with discrete confirmation points without too much effort. The probe could be arranged in the vessel diagonally in order to provide an approximate level indication whether the vessel is used horizontally in a gas cabinet (most typical) or vertically in some future gas cabinet configuration as for example, bubblers are currently used now. It is anticipated that the same vessel could be used to supply a range of new liquid precursors as the semiconductor industry evolves. One solution involves a probe that incorporates four sensing levels. In order to obtain better resolution in the area the customer is most concerned about the levels might be arranged to indicate for example, 50%; 30%, 20% and 10%.

The present invention provides many advantages. The invention provides a delivery vessel for liquefied gases that prevents liquid from being withdrawn. In particular, the withdrawal apparatus is arranged to only allow vapor withdrawal with a cylinder in any proper orientation. The invention also provides a cost effective solution that allows customers to know if they still have sufficient liquid remaining in a vessel without requiring changes to their existing tool architecture or infrastructure. Alternatively, some small infrastructure enhancements will provide additional benefit with level indication on the main plant SCADA system with alarms to attract the operator's attention should levels get low or the system should malfunction. The invention also provides for an improved level check procedure that avoids the use of external devices, such as scales, particularly where the associated tool does not have sufficient space. Also the invention provides these advantages without the need to supply power to the cylinder.

As such, in a first embodiment, there is disclosed a liquid gas cylinder comprising a hollow body whose length is a vertical wall having interior and exterior surfaces connected to a preferably circular bottom segment and a preferably circular top segment wherein the circular top segment has an opening to allow the passage of at least one valve assembly, wherein a liquid level measuring device is inserted through the circular top segment into the hollow body of the liquid gas cylinder.

In a second embodiment, there is disclosed a method for measuring a liquid level in a liquid gas cylinder wherein the liquid gas comprises a hollow body whose length is a vertical wall having interior and exterior surfaces connected to a preferably circular bottom segment and a preferably circular top segment wherein the circular top segment has an opening to allow the passage of at least one valve assembly comprising inserting a liquid level measuring device into the hollow body of the liquid gas cylinder.

It is anticipated that other embodiments and variations of the present invention will become readily apparent to the skilled artisan in the light of the foregoing description, and it is intended that such embodiments and variations likewise be included within the scope of the invention.

Having thus described the invention, what I claim is:

1. A liquid gas cylinder comprising a hollow body whose length is a vertical wall having interior and exterior surfaces connected to a circular bottom segment and a circular top segment wherein the circular top segment has an opening to allow the passage of at least one valve assembly, wherein a liquid level measuring device is inserted through the circular top segment into the hollow body of the liquid gas cylinder.

2. The liquid gas cylinder as claimed in claim 1 wherein the liquid level measuring device is selected from the group consisting of a conductivity probe, a capacitance probe, and a continuity sensor.

3. The liquid gas cylinder as claimed in claim 2 wherein the capacitance probe is covered by a layer of insulation.

4. The liquid gas cylinder as claimed in claim 1 wherein the vertical wall, circular bottom segment and circular top segment are made of stainless steel.

5. The liquid gas cylinder as claimed in claim 1 wherein a liquid is present in the hollow body.

6. The liquid gas cylinder as claimed in claim 1 wherein the liquid is present up to 40% by volume of the hollow body.

7. The liquid gas cylinder as claimed in claim 1 wherein the at least one valve assembly is a product withdrawal tube for withdrawing vapor from the hollow body.

8. The liquid gas cylinder as claimed in claim 1 further comprising a low liquid level display mounted on the circular top segment.

9. The liquid gas cylinder as claimed in claim 8 wherein the low liquid level display is an indicator comprising a green light emitting diode light and a red light emitting diode light.

10. The liquid gas cylinder as claimed in claim 1 wherein the low liquid level display is mounted on an end of the liquid level measuring device not in the hollow body.

11. The liquid gas cylinder as claimed in claim 1 wherein a sintered metal frit is mounted on an end of the valve assembly in the hollow body.

12. The liquid gas cylinder as claimed in claim 7 wherein the product withdrawal tube comprises a tube having substantially parallel walls.

13. The liquid gas cylinder as claimed in claim 12 wherein the product withdrawal tube comprises a tube having walls which are conically tapered so that the walls at a front end of the tube are closer than the walls at a back end of the tube.

14. The liquid gas cylinder as claimed in claim 1 further comprising a fill port extending through the circular top segment into the hollow body.

15. The liquid gas cylinder as claimed in claim 1 wherein the liquid gas cylinder is mounted in a position selected from the group consisting of horizontally, vertically and at an angle between horizontal and vertical.

16. The liquid gas cylinder as claimed in claim 2 wherein the conductivity probe or capacitance probe are situated in the hollow body to allow them to sense when the liquid volume is 10% by volume of the hollow body.

17. The liquid gas cylinder as claimed in claim 1 further comprising indexing feet mounted on the exterior surface of the hollow body.

18. A method for measuring a liquid level in a liquid gas cylinder wherein the liquid gas comprises a hollow body whose length is a vertical wall having interior and exterior surfaces connected to a circular bottom segment and a circular top segment wherein the circular top segment has an opening to allow the passage of at least one valve assembly comprising inserting a liquid level measuring device into the hollow body of the liquid gas cylinder.

19. The method as claimed in claim 18 wherein the liquid level measuring device is selected from the group consisting of a conductivity probe, a capacitance probe, an ultrasonic sensor, an acoustic sensor and a continuity sensor.

20. The method as claimed in claim 18 wherein the liquid is present up to 40% by volume of the hollow body.

21. The method as claimed in claim 18 wherein the at least one valve assembly is used for withdrawing vapor from the hollow body.

22. The method as claimed in claim 18 further comprising a low liquid level display mounted on an exterior surface of the cylinder.

23. The method as claimed in claim 22 wherein the low liquid level display is an indicator comprising a green light emitting diode light and a red light emitting diode light.

24. The method as claimed in claim 18 wherein the low liquid level display is mounted on an end of the liquid level measuring device not in the hollow body.

25. The method as claimed in claim 18 wherein a sintered metal frit is mounted on an end of the valve assembly in the hollow body.

26. The method as claimed in claim 18 wherein the liquid gas cylinder is mounted in a position selected from the group consisting of almost horizontal and vertical.

27. The method as claimed in claim 18 further comprising indexing feet mounted on the exterior surface of the hollow body.

28. The method as claimed in claim 18 wherein the liquid gas cylinder is mounted on a tool.

29. The method as claimed in claim 28 wherein the liquid gas cylinder delivers gas to the tool.

30. The method as claimed in claim 18 wherein a user is notified when approximately 10% by volume of liquid remains in the hollow body.

31. The method as claimed in claim 21 wherein the at least one valve assembly is a product withdrawal tube having substantially parallel walls.

32. The method as claimed in claim 31 wherein the product withdrawal tube comprises a tube having walls which are conically tapered so that the walls at a front end of the tube are closer than the walls at a back end of the tube.
